(19) United States
(12) Patent Application Publication
(10) Pub. No.: US 2020/0050919 A1
(43) Pub. Date: Feb. 13, 2020

(54) METHODS AND SYSTEMS FOR ENCODING AND PROCESSING SYMBOL STRUCTURES USING VECTOR-DERIVED TRANSFORMATION BINDING

(71) Applicant: Applied Brain Research Inc., Waterloo (CA)

(72) Inventors: Jan Gosmann, Waterloo (CA); Christopher David Eliasmith, Waterloo (CA)

(21) Appl. No.: 16/536,510

(22) Filed: Aug. 9, 2019

Related U.S. Application Data
(60) Provisional application No. 62/716,882, filed on Aug. 9, 2018.

(51) Int. Cl. G06N 3/04; G06N 3/063; G06F 9/30; G06F 17/16

(52) U.S. Cl. CPC G06N 3/049; G06F 17/16; G06F 9/30036; G06N 3/063

(57) ABSTRACT

The present invention relates to methods and systems for encoding and processing symbol structures using vector-derived transformation binding. The system comprises a plurality of binding subsystems that implement a vector-derived transformation binding operation, a plurality of unbinding subsystems that implement a vector-derived transformation unbinding operation, a plurality of cleanup subsystems that match noisy or corrupted vectors to their uncorrupted counterparts, and at least one input symbol representation that propagates activity through the binding subsystem, the unbinding subsystem, and the cleanup subsystem to produce high-dimensional vector representations of symbolic structures. The binding, the unbinding, and the cleanup subsystems are artificial neural networks implemented in network layers.

### (1) FIELD OF THE INVENTION

The present invention generally relates to the field of encoding and processing symbolic structure and more particularly the present invention relates to methods and systems for encoding and processing symbol structures using vector-derived transformation binding.

### (2) BACKGROUND OF THE INVENTION

The manipulation of symbolic information is a central feature of many intelligent behaviors, including planning, reasoning, and the use of language. Efforts to reproduce these behaviors in artificial systems have traditionally involved either the use of conventional computer algorithms that operate of symbolic data structures, or the use of artificial neural networks (ANNs) whose changing activity patterns are taken to encode such structures. To solve the challenge of mapping between symbol structures and ANN activities the concept of a ‘vector symbolic architecture’ (VSA) is introduced in which symbols are mapped to vectors in a high-dimensional space, and operations on these vectors are used to implement symbol processing. In practical applications of VSAs, the choice of binding operation is of central importance for at least two reasons. First, because binding preserves vector dimensionality, it acts as a form of lossy compression. The degree of compression loss in turn determines the ease with which complex symbol structures can be accurately processed. Second, different binding operations require differing amounts of connectivity in the neural networks that implement them. If these networks are run on specialized hardware devices that impose connectivity constraints, the choice of an appropriate binding operation can be essential.

A number of different types of device for encoding and processing and decoding symbol structure are available in prior art. For example, the following patents are provided for their supportive teachings and are all incorporated by reference: Prior art document, EP2741242A1 discloses methods, systems, and apparatus that provide for perceptual, cognitive, and motor behaviors in an integrated system implemented using neural architectures. Components of the system communicate using artificial neurons that implement neural networks. The connections between these networks form representations—referred to as semantic pointers—which model the various firing patterns of biological neural network connections. Semantic pointers can be thought of as elements of a neural vector space, and can implement a form of abstraction level filtering or compression, in which high-dimensional structures can be abstracted one or more times thereby reducing the number of dimensions needed to represent a particular structure.

Another prior art document, http://www2.fiit.stuba.sk/—kvasnicka/CognitiveScience/6.prednaska/plate.icee95.pdf describes methods for representing more complex compositional structure in distributed representations. The methods use circular convolution to associate items, which are represented by vectors. Arbitrary variable binding, short sequences of various lengths, simple frame like structures, and reduced representations can be represented in a fixed width vector. These representations are items in their own right, and can be used in constructing compositional structures. The noisy reconstruction extracted from convolution memories can be cleared up by using a separate associative memory that has good reconstructive properties.

Yet another prior art document, https://arxiv.org/labs/cs/0412059 discussed solving the challenge of mapping between symbol structures and ANN activities, researchers have introduced the concept of a ‘vector symbolic architecture’ (VSA) in which symbols are mapped to vectors in a high-dimensional space, and operations on these vectors are used to implement symbol processing

However, above mentioned references and many other similar references has one or more of the following shortcomings: (a) high compression loss; (b) quickly reduction of vector norm; (c) complex retrieval of complex symbolic structure; and (d) nonlinear processing.

The present application addresses the above-mentioned concerns and shortcomings with regard to providing the methods and systems for encoding and processing symbol structures using vector-derived transformation binding.

### (3) SUMMARY OF THE INVENTION

In the view of the foregoing disadvantages inherent in the known types of encoding and processing symbolic structure and the concept of vector symbolic architectures present in the prior art, the present invention provides methods and systems for encoding and processing symbol structures using vector-derived transformation binding for implementing procedures for encoding and processing symbolic data. As such, the general purpose of the present invention, which will be described subsequently in greater detail, is to provide methods and systems for encoding and processing symbol structures using vector-derived transformation binding which has all the advantages of the prior art and none of the disadvantages.

The main aspect of the present invention is to provide methods and systems for encoding and processing symbol structures using vector-derived transformation binding. The methods and systems for encoding and processing symbol structures using vector-derived transformation binding are comprised of a plurality of binding subsystems that implement a vector-derived transformation binding operation, a plurality of unbinding subsystems that implement a vector-derived transformation unbinding operation, a plurality of cleanup subsystems that match noisy or corrupted vectors to their uncorrupted counterparts, and at least one input symbol representation that propagates activity through the binding subsystem, the unbinding subsystem and the cleanup subsystem to produce high-dimensional vector representations of symbolic structures. The binding, the unbinding, and the cleanup subsystems are artificial neural networks implemented in network layers. Each network layer comprises a plurality of nonlinear components. The nonlinear component is configured to generate an output in response to the input symbol. The output from each nonlinear component is weighted by coupling weights of corresponding weighted couplings and weighted outputs are provided to coupled the network layers. The symbolic structure corresponds to a plurality of data structures and a plurality of human-interpretable data types.

Another aspect of the present invention is to provide the input symbols to the system which are either discrete or continuous in time

Yet another aspect of the present invention is to provide the binding and the unbinding networks that apply a constant binding or unbinding operation to a single input symbol representation.

Still another aspect of the present invention is to provide the binding and the unbinding networks that apply a variable binding or unbinding operation determined by one input symbol representation to a second input symbol representation.

Yet another aspect of the present invention is to provide the binding, the unbinding, and the cleanup networks that are implemented repeatedly, recursively, and/or sequentially to perform multiple steps of symbol processing.

Still another aspect of the present invention is to provide the nonlinear components that are software simulations of neurons to generate spikes.

Yet another aspect of the present invention is to provide the nonlinear components that are implemented in special purpose hardware and/or through special purpose hardware further comprising neuromorphic computers.

A final aspect of the present invention provides the methods for encoding and processing symbol structures using vector-derived transformation binding which is comprised of following steps:
i. Defining a plurality of said binding subsystems that implement a vector-derived transformation binding operation.
ii. Defining a plurality of said unbinding subsystems that implement the approximate inverse of a vector-derived transformation binding operation;
iii. Defining a plurality of said cleanup subsystems that match noisy or corrupted vectors to their uncorrupted counterparts; and,
iv. Defining at least one or more input symbol representations that propagate activity through the said binding subsystem, said unbinding subsystem, and said cleanup subsystems to produce high-dimensional vector representations of said symbolic structures.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### (4) BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an illustration of the differences between VTB and circular convolution with respect to their effects on the vector norm and compression loss after binding and unbinding with random vectors;

FIG. 2 is an illustration of the differences between VTB and circular convolution with respect to their effects on the vector norm and compression loss after auto-binding and unbinding a vector;

FIG. 3 is an illustration of the differences between VTB and circular convolution with respect to their effects on compression loss in the context of decoding stack elements at varying depths; and

FIG. 4 is an illustration of the connection weight and connectivity patterns required by VTB and circular convolution.

### (5) DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention is described in brief with reference to the accompanying drawings. Now, refer in more detail to the exemplary drawings for the purposes of illustrating non-limiting embodiments of the present invention.

As used herein, the term “comprising” and its derivatives including “comprises” and “comprise” include each of the stated integers or elements but does not exclude the inclusion of one or more further integers or elements.

As used herein, the singular forms “a”, “an”, and “the” include plural referents unless the context clearly dictates otherwise. For example, reference to “a device” encompasses a single device as well as two or more devices, and the like.

As used herein, the terms “for example”, “like”, “such as”, or “including” are meant to introduce examples that further clarify more general subject matter. Unless otherwise specified, these examples are provided only as an aid for understanding the applications illustrated in the present disclosure, and are not meant to be limiting in any fashion.

As used herein, the terms “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

For simplicity and clarity of illustration, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

The embodiments of the digital circuits described herein may be implemented in configurable hardware (i.e. FPGA) or custom hardware (i.e. ASIC), or a combination of both with at least one interface. The input signal is consumed by the digital circuits to perform the functions described herein and to generate the output signal. The output signal is provided to one or more adjacent or surrounding systems or devices in a known fashion.

As used herein the term ‘neuron’ refers to spiking neurons, continuous rate neurons, or arbitrary non-linear components used to make up a distributed system.

The described systems can be implemented using adaptive or non-adaptive components. The system can be efficiently implemented on a wide variety of distributed systems that include a large number of non-linear components whose individual outputs can be combined together to implement certain aspects of the system as will be described more fully herein below.

The main embodiment of the present invention is to provide methods and systems for encoding and processing symbol structures using vector-derived transformation binding. The methods and systems for encoding and processing symbol structures using vector-derived transformation binding are comprised of a plurality of binding subsystems that implement a vector-derived transformation binding operation, plurality of unbinding subsystems that implement a vector-derived transformation unbinding operation, a plurality of cleanup subsystems that match noisy or corrupted vectors to their uncorrupted counterparts, and at least one input symbol representation that propagates activity through the binding subsystem, the unbinding subsystem and the cleanup subsystem to produce high-dimensional vector representations of symbolic structures. The binding, the unbinding, and the cleanup subsystems are artificial neural networks implemented in network layers. Each network layer comprises a plurality of nonlinear components. The nonlinear component is configured to generate an output in response to the input symbol. The output from each nonlinear component is weighted by coupling weights of corresponding weighted couplings and weighted outputs are provided to coupled the network layers. The symbolic structure corresponds to a plurality of data structures and a plurality of human-interpretable data types. The plurality of data structures may include graphs, lists, trees, stacks, and sequences. The plurality of human-interpretable data types may include words, numbers, characters, images, and sounds. The term ‘symbol’ alone refers to either basic or complex symbols. The neural network layer in the present invention refers to a collection of simulated neurons that accumulate input from one or more other collections of simulated neurons and propagates output to one or more other collections of simulated neurons.

A ‘binding network’ here refers to a neural network whose connection weights implement the VTB operation. The vector-derived transformation binding operation is used to create pairwise bindings that link individual symbols to particular locations in a stack, list, graph, or tree. These bindings are collected via superposition into a single vector representation. The input symbols in the present invention are represented as random unit-length vectors of dimension d, which ensures that the vector components are identically distributed, and that all of the vectors are approximately orthogonal to one another. Input symbol comparisons are perform via the normalized dot product, which is close to zero for all approximately orthogonal vectors. Comparisons of this sort are use to interpret the result of transformations of symbol structures built using the VTB operation. For example, a parse tree of a sentence might be encode into a single fixed-length vector using VTB, and manipulations of this vector may be used to decode out a representation corresponding to the subject noun in the sentence. Dot products can used to match this decoded vector representation to the unit-length vector corresponding to a particular symbol. Mathematically, VTB is defined as follows. Given a dimensionality dj=d^{t/2}∈R^{>0}, the vector-derived transformation binding operator Bv: Rd×Rd→Rd is defined as:

$$\begin{matrix}{B}_{V} ( x , y ) := {V}_{y} x = [ \begin{matrix}{V}_{y}^{′} & 0 & 0 \\ 0 & {V}_{y}^{′} & 0 \\ 0 & 0 & ⋱\end{matrix} ] x \\ With & ( 1 ) \\ {V}_{y}^{′} = {d}^{\frac{1}{4}} [ \begin{matrix}{y}_{1} & {y}_{2} & … & {y}_{{d}^{′}} \\ {y}_{{d}^{′} + 1} & {y}_{{d}^{′} + 2} & … & {y}_{2 {d}^{′}} \\ ⋮ & ⋮ & ⋱ & ⋮ \\ {y}_{d - {d}^{′} + 1} & {y}_{d - {d}^{′} + 2} & … & {y}_{d}\end{matrix} ] . & ( 2 )\end{matrix}$$

This binding operator relies on the fact that the vectors x and y are usually picked randomly from a uniform distribution of unit-length vectors. That implies that V_{y} is approximately orthogonal: V_{y}^{T}V_{y}≈I. This makes the binding operation a random transformation of x based on y, thus ensuring that the result will be dissimilar to both inputs (for most vectors as long as x does not happen to be an eigenvector of V_{y}).

An ‘unbinding network’ refers to a neural network that inverts the VTB operation to extract one of the two items in a bound pair. The vector-derived transformation unbinding operation and/or rebinding operation is used to extract particular symbols from particular locations, before rebinding them to other locations to perform arbitrary symbol transformations. To invert a binding operation and extract symbols or output of the items in a bound pair BV(x, y), the approximate inverse of the VTB operator is defined as:

$${B}_{V}^{+} ( x , y ) = {V}_{y}^{′ T} x = [ \begin{matrix}{V}_{y}^{′ T} & 0 & 0 \\ 0 & {V}_{y}^{′ T} & 0 \\ 0 & 0 & ⋱\end{matrix} ] x . \qquad ( 3 )$$

Optionally this unbinding operation could also be learned using standard ANN (artificial neural networks) methods in contrast to circular convolution; VTB is neither commutative nor associative. Thus, a separate unbinding step is required for each binding, whereas circular convolution permits undoing multiple bindings in one step. It is, however, possible to flip the operands of a VTB binding in the bound state by multiplying with a specific permutation matrix. The representations decoded from a symbol structure built with VTB are noisy and only somewhat similar to the vector corresponding to the matching constituent symbol. The cleanup memory is used to match a noisily decoded vector to its clean counterpart. If the decoded representation is too noisy, the cleanup memory will produce an incorrect match, yielding erroneous symbol processing. The degree of noise present during decoding is determined both by the complexity of the symbol structure being decoded, and by the amount of compression loss introduced by the binding operation being used. Cleanup memories are implemented either as closed-form functions (e.g., max), in spiking neural networks, or in non-spiking neural networks.

The individual computing elements within the neural networks used to perform the binding operation, the unbinding operation, and to clean up vector representations processed using the VTB operation can vary. Optionally computing elements or input symbols transmit a constant value determined by the input, and are thereby non-spiking and sometimes the computing elements emit occasional pulses in a manner determined by their input, and are thereby spiking. Spiking versions of the neural networks are in some cases implemented using conventional computers via software that emulates the process by which a neuron input triggers a spike. In other cases, the neural networks are implemented using neuromorphic hardware that physically instantiates spike-based communication between computing elements. The binding and the unbinding networks in the present invention apply a constant binding or unbinding operation to a single input symbol representation. The binding and the unbinding networks apply a variable binding or unbinding operation determined by one input symbol representation to a second input symbol representation.

The input symbol processing in the present invention with the VTB operation can involve arbitrary sequences of binding, unbinding, and cleanup operations, each of which are implemented by binding networks, unbinding networks, and cleanup networks, respectively. The same networks may be used repeatedly by communicating the outputs of one network to the input of another network in arbitrary sequential order. Optionally, multiple networks may be coupled to one another in arbitrary sequential order.

The nonlinear components can be implemented using a combination of adaptive and non-adaptive components. The system can be efficiently implemented on a wide variety of distributed systems that include a large number of nonlinear components whose individual outputs can be combined together to implement certain binding and unbinding operations. Examples of nonlinear components that can be used in various embodiments described herein include simulated/artificial neurons, FPGAs, GPUs, and other parallel computing systems. Components of the system may implemented using a variety of standard techniques such as by using microcontrollers. In addition, optionally non-linear component may be implemented in various forms including software simulations, hardware, or any neuronal fabric. In multiple medium non-linear component may implement such as Neurogrid, Spinnaker, OpenCL, Loihi, and TrueNorth.

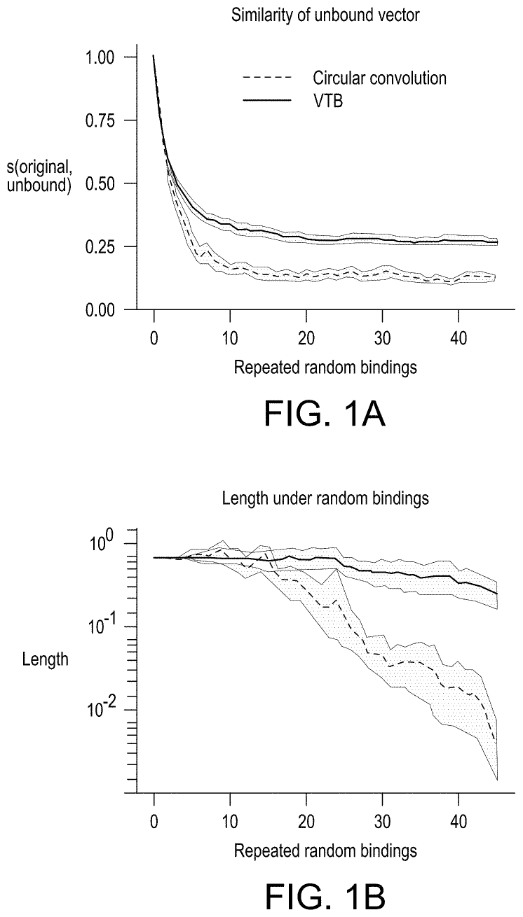

For any binding operation, if a vector is bound into a pair and unbound again, the unbound result should be similar to the original vector (as measured by the normalized dot product). A high degree of similarity indicates that the binding operation introduces minimal compression loss. FIG. 1 is an illustration of the differences between VTB and circular convolution with respect to their effects on the vector norm and compression loss after binding and unbinding with random vectors. While the similarity declines quickly for both binding methods, the VTB flattens out at a higher similarity. FIG. 1 also shows the change in the vector norm with increasing numbers of bindings. Circular convolution quickly reduces the norm, while the norm declines much more slowly with VTB. Together, these results indicate that the VTB operation introduces less compression loss than circular convolution, while more accurately maintaining the vector norm during symbol processing.

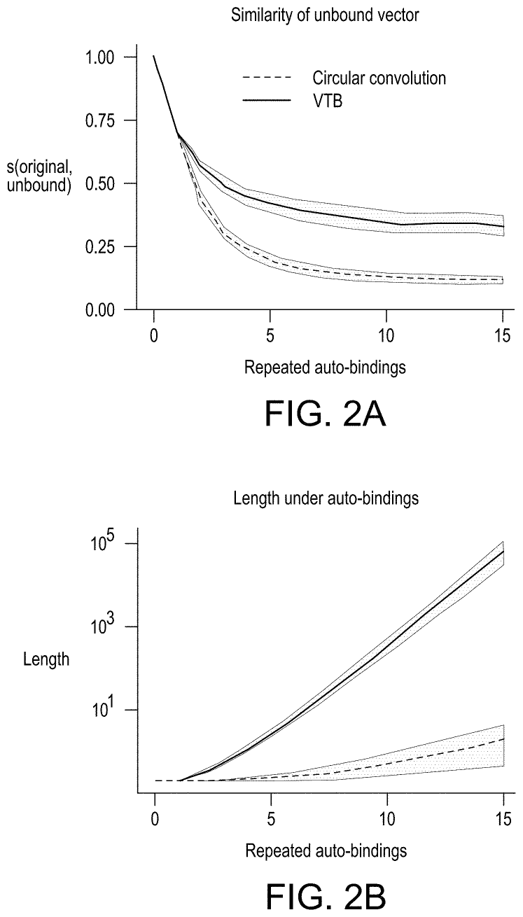

To efficiently process lists, the same vector can be repeatedly bound to itself to incrementally index list positions. The term auto-binding in the present invention refers here to the process of repeatedly binding a vector with itself. FIG. 2 is an illustration of the differences between VTB and circular convolution with respect to their effects on the vector norm and compression loss after auto-binding and unbinding a vector; FIG. 2 also shows the change in the vector norm with increasing numbers of bindings. Again, these results indicate that the VTB operation introduces less compression loss than circular convolution, while more accurately maintaining the vector norm during symbol processing.

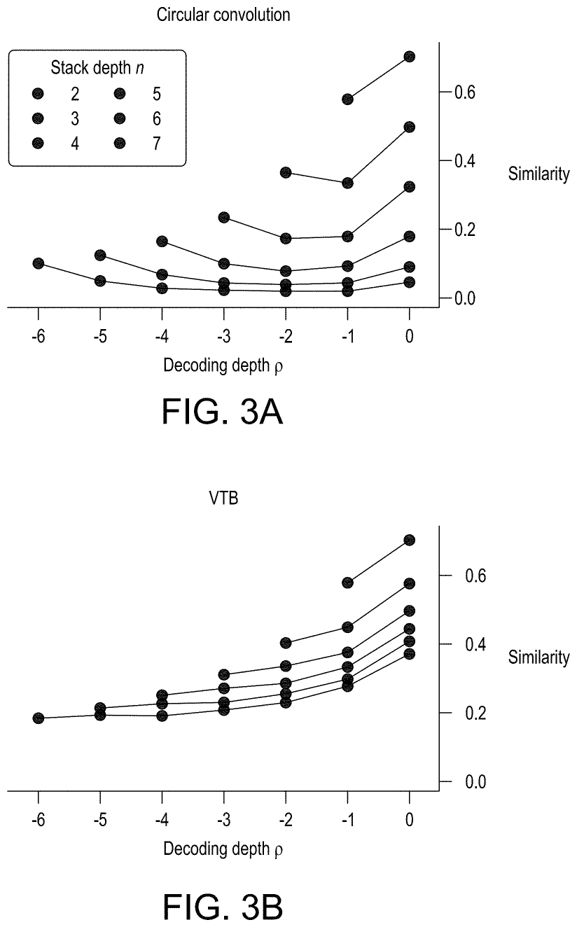

Stacks are another data structure usefully processed using the embodied elements, for two main reasons. First, after repeated binding and unbinding, the resulting vector will be more similar to the original vector with VTB. Second, the vector norm will change less with each binding, facilitating a neural implementation where representational accuracy is sensitive to this norm. FIG. 3 is an illustration of the differences between VTB and circular convolution with respect to their effects on compression loss in the context of decoding stack elements at varying depths. The VTB enables the retrieval of deeper stack elements with less compression loss. This improved stack processing capacity can be beneficial in a number of scenarios. For example, it can reduce the degree to which cleanup memories are needed to remove noise when extracting information from highly complex symbols. Such input symbols are useful for representing hierarchically structured knowledge, such as the fact that a penguin is a bird, which in turn is an animal. Other, optional applications of VTB processing include the manipulation of sequences and parse trees. In addition to capturing the potential depth of these trees, VTB is non-commutative and thus retains which element is the left and right child of a tree node.

To implement binding, unbinding, and cleanup networks with spiking neurons, the standard leaky integrate-and-fire (LIF) neuron model may be used in all network layers. Optionally, other spiking neuron models may be used. The vectors corresponding to basic symbols that initially provide input to the system are encoded into spiking activities by injecting a current J into each input layer neuron. This current is proportional to the similarity between the supplied input vector and a vector that characterizes the ‘preferred’ vector of the neuron. The activity of a neuron can be calculated based on the input current, J, and a nonlinear neuron model G, yielding the activity of each neuron a as:

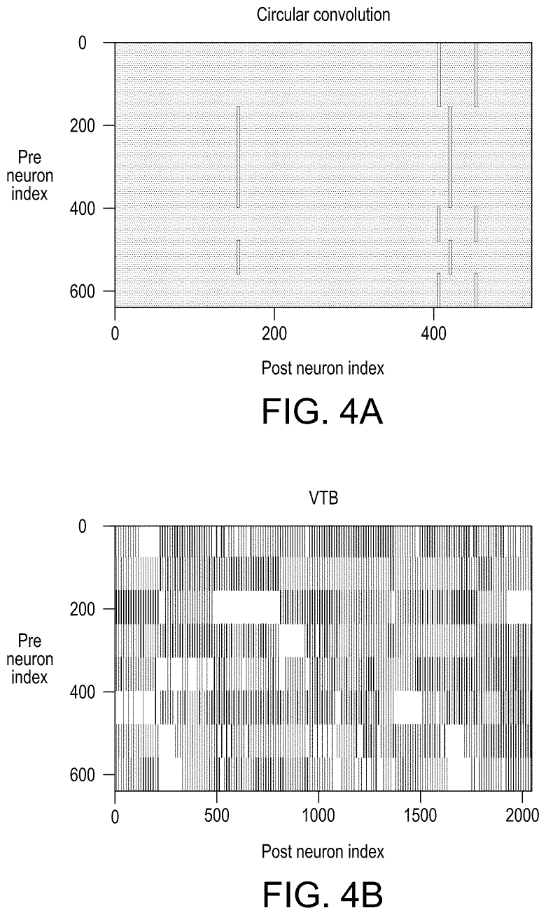

In terms of neural resources, VTB requires less connectivity in a neural network than circular convolution. Circular convolution requires 332,800 connections for binding two 64-dimensional vectors when using five neurons per dimension. VTB requires 5120 fewer connections, a total of 327,680, for the same task when representing the vectors as 16-dimensional sub vectors. FIG. 4 is an illustration of the connection weight and connectivity patterns required by VTB and circular convolution for 64-dimensional vectors with five neurons per dimension. Black lines mark existing connections of any strength, while white lines mark no existing connections.

The input symbols to the system in the present invention are either discrete or continuous in time. The binding, the unbinding, and the cleanup networks may be implemented repeatedly, recursively, and/or sequentially to perform multiple steps of symbol processing.

The methods for encoding and processing symbol structures using vector-derived transformation binding which is comprised of the following steps:
i. Defining a plurality of said binding subsystems that implement a vector-derived transformation binding operation.
ii. Defining a plurality of said unbinding subsystems that implement the approximate inverse of a vector-derived transformation binding operation;
iii. Defining a plurality of said cleanup subsystems that match noisy or corrupted vectors to their uncorrupted counterparts; and,
iv. Defining at least one input symbol representation that propagates activity through the said binding subsystem, said unbinding subsystem, and said cleanup subsystem to produce high-dimensional vector representations of said symbolic structures.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A system for encoding and processing symbol structures using vector-derived transformation binding comprising:
a plurality of binding subsystems that implement a vector-derived transformation binding operation,
a plurality of unbinding subsystems that implement a vector-derived transformation unbinding operation,
a plurality of cleanup subsystems that match noisy or corrupted vectors to their uncorrupted counterparts,
at least one input symbol representation that propagates activity through said binding subsystem, said unbinding subsystem and said cleanup subsystem to produce high-dimensional vector representations of symbolic structures, and
wherein said binding, said unbinding, and said cleanup subsystems are artificial neural networks implemented in network layers, and wherein each said network layer comprises a plurality of nonlinear components, and each said nonlinear component is configured to generate an output in response to said input symbol, and wherein said output from each said nonlinear component is weighted by coupling weights of corresponding weighted couplings and weighted outputs are provided to coupled said network layers, and wherein said symbolic structure corresponds to plurality of data structures and a plurality of human-interpretable data types.

2. The system for encoding and processing symbol structures using vector-derived transformation binding according to claim 1, wherein said input symbol to the system are either discrete or continuous in time.

3. The system for encoding and processing symbol structures using vector-derived transformation binding according to claim 1, wherein said binding and said unbinding networks apply a constant binding or unbinding operation to a single input symbol representation.

4. The system for encoding and processing symbol structures using vector-derived transformation binding according to claim 1, wherein said binding and said unbinding networks apply a variable binding or unbinding operation determined by one input symbol representation to a second input symbol representation.

5. The system for encoding and processing symbol structures using vector-derived transformation binding according to claim 1, wherein said binding, said unbinding and said cleanup networks are implemented repeatedly, recursively, and/or sequentially to perform multiple steps of symbol processing.

6. The system for encoding and processing symbol structures using vector-derived transformation binding according to claim 1, wherein said nonlinear components are software simulations of neurons to generate spikes.

7. The system for encoding and processing symbol structures using vector-derived transformation binding according to claim 1, wherein said nonlinear components are implemented in special-purpose hardware further comprising neuromorphic computers.

8. The method for encoding and processing symbol structures using vector-derived transformation binding of the said system of claim 1, wherein said method is comprised of the following steps:
i. defining a plurality of said binding subsystems that implement a vector-derived transformation binding operation.
ii. defining a plurality of said unbinding subsystems that implement the approximate inverse of a vector-derived transformation binding operation;
iii. defining a plurality of said cleanup subsystems that match noisy or corrupted vectors to their uncorrupted counterparts; and,
iv. defining at least one input symbol representation that propagates activity through the said binding subsystem, said unbinding subsystem, and said cleanup subsystems to produce high-dimensional vector representations of said symbolic structures.
